(19) United States
(12) Patent Application Publication
(10) Pub. No.: US 2026/0330662 A1
(43) Pub. Date: Oct. 22, 2026

(54) REGISTRATION METHOD AND DEVICE FOR DEFOCUS SERIES OF TRANSMISSION ELECTRON MICROSCOPY IMAGES WITH HIGH NOISE

(71) Applicant: Zhejiang University of Technology, Hangzhou (CN)

(72) Inventors: Yihan Zhu, Hangzhou (CN); Xinru Jiang, Changsha (CN)

(21) Appl. No.: 19/401,381

(22) Filed: Nov. 26, 2025

(30) Foreign Application Priority Data
Apr. 22, 2025 (CN) 202510507267.8

(51) Int. Cl. G06T 7/38; G06T 5/50; G06T 5/70; G06T 5/80; G06T 7/37

(52) U.S. Cl. CPC G06T 7/38; G06T 5/50; G06T 5/70; G06T 5/80; G06T 7/37; G06T 2207/10016; G06T 2207/10061; G06T 2207/20056

(57) ABSTRACT

A registration method and device for a defocus series of transmission electron microscopy images with high noise are provided. The registration method includes leveraging synergistic effects of frequency-domain modulation and information entropy optimization, specifically through Fourier transform to extract amplitude information of structural signals and combined with multiple types of frequency-domain modulation functions to achieve noise spectral energy suppression and effective signal frequency band enhancement in a frequency domain; subsequently calculating mutual information based on frequency-domain modulated images, and utilizing nonlinear correlation of frequency-domain signal statistical distributions to overcome a defect of noise sensitivity of intensity matching in the art, thereby driving robust registration.

### CROSS-REFERENCE TO RELATED APPLICATION

This application claims priority to Chinese Patent Application No. 202510507267.8, filed on Apr. 22, 2025, which is herein incorporated by reference in its entirety.

### TECHNICAL FIELD

The disclosure relates to the field of electron microscopy image processing technologies, and more particularly to a registration method and device for defocus series of transmission electron microscopy (TEM) images with high noise based on frequency-domain modulation and information entropy, which is suitable for automatic alignment of multi-frame defocus images obtained by the TEM, a scanning transmission electron microscopy (STEM) and other equipment under low-dose conditions and is widely used in high-resolution electron microscopy techniques such as low-dose imaging, exit wave reconstruction, and electron tomography.

### BACKGROUND

In TEM and STEM imaging, low-dose imaging technique has become a key means for studying electron-beam-sensitive materials (such as biological samples, two-dimensional materials, metal organic frameworks, abbreviated as MOF, etc.) by reducing electron-beam irradiation damage. However, low-dose conditions significantly reduce a signal-to-noise ratio (SNR) of images, severely limiting accuracy of registration methods in the art that rely on gradient or feature point matching. At the same time, for applications such as exit wave reconstruction and electron tomography, it is necessary to acquire defocus series images containing different defocus amounts and achieve multimodal data fusion through high-precision registration. However, the defocus series images, due to dynamic change of the defocus amounts, face dual challenges in registration problem thereof: firstly, difference in the defocus amounts can cause nonlinear distortion of apparent features of a same structure (such as edge sharpness and phase contrast drift), which violates strength or structural consistency assumptions that algorithms in the art rely on; and secondly, defocus-induced diffraction effects further introduce local phase and amplitude distortions, leading to failure of frequency-domain phase matching methods.

In registration tasks in the art of electron microscopy images, image registration methods commonly used include cross correlation (CC), geometric phase correlation (GPC), bUnwarpJ algorithm, etc., which can achieve good results in general low-noise or optical microscopy image processing. However, when these image registration methods are applied to defocus series images with high noise, stability and accuracy of these image registration methods are significantly reduced. A main reason is that these image registration methods rely on global features or frequency-domain information of images during a registration process, noise distribution of the defocus series images is complex, and contrast of the images at different focal lengths varies significantly, making it difficult for the image registration methods in the art to extract stable matching features. Therefore, under the low-dose conditions, the nonlinear distortion of the apparent features of the same structure caused by a decrease in SNR and the differences in the defocus amounts forms coupling interference, making it difficult for the imaging registration methods in the art to balance robustness and sub-pixel accuracy, seriously restricting application effect of high-resolution reconstruction.

### SUMMARY

To overcome the aforementioned deficiencies, the disclosure provides a frequency-domain modulation and information entropy based registration (FDMIE-Reg) method and device based on frequency-domain modulation and information entropy for defocus series of TEM images with high noise which are applicable in exit wave reconstruction, electron tomography, and other electron microscopy techniques that require high-precision image registration of radiation sensitive materials to support key operations such as phase recovery.

In response to insufficient accuracy and stability of CC, GPC, and a bUnwarpJ algorithm in registration for the defocus series of TEM images with high noise, the disclosure provides a registration method based on the frequency-domain modulation and the information entropy for the defocus series of TEM images with high-noise. The registration method enhances structural main frequency information through the frequency-domain modulation to suppress noise interference and combines a statistical correlation optimization strategy based on the information entropy to resist grayscale drift caused by changes in defocus amounts, thereby significantly improving registration accuracy and robustness of high-noise TEM data. The registration method is especially suitable for electron microscopy techniques that rely on high-precision image registration, such as the exit wave reconstruction and the electron tomography and can provide a reliable data foundation for the phase recovery of the radiation-sensitive materials.

In a first aspect, the registration method for the defocus series of TEM images with high noise provided by the disclosure includes the following steps:
(1) obtaining a defocus series of electron microscopy images with high noise: under low-dose shooting conditions, acquiring a set of TEM images with an equal defocus amount to form complete series images from defocus to in-focus and then to overfocus; or generating simulation data through a simulation software based on experimental conditions;
(2) performing Fourier transform on the defocus series of electron microscopy images: applying the Fourier transform frame by frame to the obtained defocus series of electron microscopy images to extract an amplitude component of each frame of the defocus series of electron microscopy images to thereby obtain amplitude components of frames of the defocus series of electron microscopy images, and accumulating the amplitude components of the frames of the defocus series of electron microscopy images to form a frequency-domain amplitude pattern, thereby enhancing periodic structural signals and suppressing random noise;
(3) enhancing frequency-domain signals: determining a modulation function to modulate the amplitude components in a frequency domain and preserve original phase information simultaneously, to thereby obtain modulated frequency-domain signals;
(4) performing inverse Fourier transform: performing the inverse Fourier transform on the modulated frequency-domain signals to obtain a denoised series of electron microscopy images;
(5) optimizing registration based on the information entropy: calculating mutual information of the denoised series of electron microscopy images, wherein the mutual information is calculated through the following steps:
   counting occurrence frequencies of each pixel intensity value in two images respectively, to thereby obtain frequency ratios;
   calculating marginal entropies of the two images, respectively, based on the frequency ratios;
   counting joint frequency distribution of a pixel intensity pair at corresponding positions between the two images, to thereby obtain a joint frequency ratio;
   calculating a joint information entropy based on the joint frequency ratio; and
   subtracting the joint entropy from a sum of the marginal entropies of the two images, to thereby obtain the mutual information;
(6) normalizing the mutual information to reduce sensitivity on sizes of overlapping regions;
(7) performing multi-scale optimization: optimizing a value of the mutual information and transformation parameters by using an optimization algorithm, to thereby obtain optimal registration parameters that maximize the value of mutual information;
(8) calculating and correcting global registration of the defocus series of electron microscopy images based on an iteratively optimized value of mutual information to thereby obtain a registered defocus series of electron microscopy images; and
(9) assessing registration results: establishing control groups, applying different registration methods to the control groups to obtain registered defocus series of electron microscopy images of the control groups, and quantitatively evaluating registration translation parameters of the registered defocus series of electron microscopy images of the control groups and the registered defocus series of electron microscopy images obtained in step (8) through a root mean square (RMS) error to thereby validate a registration accuracy of each of the control groups and a registration accuracy of the registered defocus series of electron microscopy images obtained in step (8); and registering a defocus series of electron microscopy images obtained by an actually low-dose technique through step (2) to step (8), followed by reconstructing to obtain a structural image, and comparing a resolution of the structural image with that of a structural image obtained by registering and reconstructing the defocus series of electron microscopy images obtained by the actually low-dose technique by a target registration method, to thereby validate registration levels.

In an embodiment, the registered defocus series of TEM images is mainly used as a data source of exit wave reconstruction technology, and is mainly used in exit wave reconstruction and electronic tomography of irradiation-sensitive materials and other electron microscopy technologies that require high-precision image registration to support key operations such as phase recovery.

In an embodiment, the defocus series of electron microscopy images in step (2) includes n frame images, thereby forming an image stack. An i-th frame image of the n frame images is expressed as fᵢ(x, y). (x,y) corresponds to a projection position of a sample in a two-dimensional space during TEM acquisition. x is a horizontal coordinate, and y is a vertical coordinate. A value of fᵢ(x,y) represents a strength of an electronic signal detected by a detector at the projection position. The frequency-domain amplitude pattern is expressed as F_{A}(u, v). u and v represent contributions of different frequency components in a spatial frequency. u corresponds to a horizontal frequency, and v corresponds to a vertical frequency. A value of F_{A} (u, v) represents a result of the Fourier transform. A mathematical meaning of the Fourier transform is to map a spatial domain to the frequency domain, and the Fourier transform is calculated through a fast Fourier transform (FFT). F_{A}(u, v) is calculated according to a formula (1) expressed as follows:

$${F}_{A} ( u , v ) = {\sum }_{i = 1}^{n} \vert \int \int {f}_{i} ( x , y ) {e}^{- 2 π i ( u x + v y )} dx dy \vert \qquad ( 1 )$$

where, an integral part in the formula (1) refers to performing continuous Fourier transform on a single frame image fᵢ(x, y), specifically calculating an inner product of the i-th frame image fᵢ(x, y) with a complex exponential wave e^{-2πi(ux=+vy)} corresponding to the i-th frame image fᵢ(x,y) to quantify a contribution of each frequency component at a frequency point (u, v) in the i-th frame image fᵢ(x, y), namely calculating a complex value of the single frame image fᵢ(x, y) at the frequency point (u, v); an absolute value part in the formula (1) refers to taking a magnitude spectrum of the Fourier transform, namely a modulus of the Fourier transform; and a summation part in the formula (1) represents superposition of frequency spectra of the n frame images, to thereby ultimately obtain F_{A}(u, v).

In an embodiment, the modulation function in step (3) includes a Gaussian modulation function, a Wiener modulation function, a soft threshold modulation function, a Gaussian high pass modulation function, and a median modulation function.

A formula (2) used for enhancing the frequency-domain signals in step (3) is expressed as follows:

Gᵢ(u,v)=H(u,v)·e^{-iΦ(u,v)} (2)
where Φ(u, v) represents a phase angle of a frequency signal, and a physical meaning of phase is to determine a spatial position of a periodic structure in a signal; Φ(u, v) in the formula (2) originates from an original signal of an image, meaning that phase information of the image remains unchanged; e^{-iΦ(u,v)} represents the original phase information of the frequency point (u, v) in the i-th frame image and is used to encode the original phase information into a complex form to facilitate synthesis of a frequency-domain signal; H(u, v) represents the modulation function and is used to modulate the amplitude components in the frequency domain; and Gᵢ(u, v) represents an enhanced signal of the frequency point (u, v) in the i-th frame image, includes modulated amplitude and phase information, and is used for subsequent inverse Fourier transform to reconstruct an enhanced spatial-domain signal.

The Gaussian modulation function in step (3) is used to enhance low-frequency signals and suppress high-frequency noise. A mathematical expression of the Gaussian modulation function is as follows:

$$H ( u , v ) = \frac{1}{2 π {σ}^{2}} {e}^{- \frac{{u}^{2} + {v}^{2}}{2 {σ}^{2}}} \qquad ( 3 )$$

where σ is a standard deviation of a Gaussian kernel (controlling ambiguity).

The Wiener modulation function in step (3) is used to minimize a mean square error (MSE) between the signal and noise, and a noise power spectrum needs to be known. A mathematical expression of the Wiener modulation function is as follows:

$$H ( u , v ) = \frac{S ( u , v )}{S ( u , v ) + N ( u , v )} \qquad ( 4 )$$

where S(u, v) represents an original signal power spectrum, and N(u, v) represents the noise power spectrum.

The soft threshold modulation function in step (3) is used to enhance specific frequency signals and remove background noise. A mathematical expression of the soft threshold modulation function is expressed as follows:

$$H ( u , v ) = \{ \begin{matrix}{F}_{A} ( u , v ) - {I}_{t} & if {F}_{A} ( u , v ) \geq {I}_{t} \\ 0 & if {F}_{A} ( u , v ) < {I}_{t}\end{matrix} \qquad ( 5 )$$

where a specified threshold Iₜ is defined as Iₜ=2×mean(F_{A})−min(F_{A}).

The Gaussian high pass modulation function in steps (3) is used to remove low-frequency artifacts and enhance high-frequency features. A mathematical expression of the Gaussian high pass modulation function is expressed as follows:

$$H ( u , v ) = 1 - {e}^{- \frac{{D}^{2} ( u , v )}{2 {D}_{0}^{2}}} \qquad ( 6 )$$

where D(u, v)=\sqrt{(u−M/2)²+(v−N/2)²}, represents a distance from the frequency point (u, v) to a spectrum center (M/2, N/2), and D₀ represents a cutoff frequency (radius) and is used to control a low frequency suppression range.

The median modulation function in step (3) is used to eliminate outlier noise points. A mathematical expression of the median modulation function is as follows:

Gᵢ(u,v)=median{I(u+i,v+j)|i,j∈[−k,k]} (7)
where k represents a modulation window radius.

In an embodiment, a mathematical expression of the inverse Fourier transform in step (4) is represented by a formula (8) expressed as follows:

gᵢ(x,y)=∫∫Gᵢ(u,v)·e^{-2πi(ux=+vy)}du dv (8)
where gᵢ(x,y) represents a spatial-domain signal recovered from a frequency-domain signal Gᵢ(u, v) through the inverse Fourier transform and includes modulated or corrected information, namely the i-th frame image in the denoised series of electron microscopy images; e^{2πi(ux=+vy)} represents conversion of each frequency component at the frequency point (u, v) of the frequency-domain signal Gᵢ(u, v) into a plane wave in the spatial domain; and an integral part in the formula (8) represents recombination of frequency components separated in the frequency domain to restore global features and local features of the i-th frame image in the spatial domain.

In an embodiment, mathematical expressions of the marginal entropies E(gᵢ) and E(gⱼ) in step (5) are as follows:

$$E ( {g}_{i} ) = - {\sum }_{{n}_{i}} \frac{K ( {n}_{i} )}{{M}_{{g}_{i}}} \cdot log \frac{K ( {n}_{i} )}{{M}_{{g}_{i}}} \qquad ( 9 )$$

$$E ( {g}_{j} ) = - {\sum }_{{n}_{j}} \frac{K ( {n}_{j} )}{{M}_{{g}_{j}}} \cdot log \frac{K ( {n}_{j} )}{{M}_{{g}_{j}}} \qquad ( 10 )$$

where gᵢ(x, y) and gⱼ(x, y) represent an i-th frame image and a j-th frame image in an image stack with n frame images performed with the inverse Fourier transform; calculating the marginal entropies E(gᵢ) and E(gⱼ) is necessarily based on inputting an occurrence frequency K(nᵢ) of a pixel intensity value nᵢ in the i-th frame image gᵢ(x, y) and an occurrence frequency K(nⱼ) of a pixel intensity value nⱼ in the j-th frame image gⱼ(x, y); nᵢ represents an intensity value of a target pixel in the i-th frame image gᵢ(x, y), and nⱼ represents an intensity value of another target pixel in the j-th frame image gⱼ(x, y) at a position corresponding to a position of the target pixel in the i-th frame image gᵢ(x, y); numbers of non-zero pixel values in the i-th frame image gᵢ(x, y) and the j-th frame image gⱼ(x, y) are summed up and denoted as M_{g}_{ᵢ} and M_{g}_{ⱼ}, respectively; and mathematical expressions of M_{g}_{ᵢ} and M_{g}_{ⱼ} are as follows:

M_{g}_{ᵢ}=Σₙ_{ᵢ}₌₁K(nᵢ) (11)

M_{g}_{ⱼ}=Σₙ_{ⱼ}₌₁K(nⱼ) (12)
where M_{g}_{ᵢ} represents a total number of the non-zero pixel values in the i-th frame image gᵢ(x, y), M_{g}_{ⱼ} represents a total number of the non-zero pixel values in the j-th frame image gⱼ(x, y); and a total number combined with an occurrence frequency is used to represent an occurrence probability of a pixel intensity value in a single image.

In an embodiment, a mathematical expression of the joint information entropy E(gᵢ, gⱼ) in step (5) is as follows:

$$E ( {g}_{i} , {g}_{j} ) = - {\sum }_{{n}_{i} , {n}_{j}} \frac{K ( {n}_{i} , {n}_{j} )}{{M}_{{g}_{i} , {g}_{j}}} \cdot log \frac{K ( {n}_{i} , {n}_{j} )}{{M}_{{g}_{i} , {g}_{j}}} \qquad ( 13 )$$

calculating the joint information entropy E(gᵢ, gⱼ) of the two images of the i-th frame image gᵢ(x, y) and the j-th frame image gⱼ(x, y) is necessarily based on an occurrence number K(nᵢ, nⱼ) of a pixel intensity value pair [nᵢ, nⱼ] of corresponding pixel positions in the two images; K(nᵢ, nⱼ) represents the occurrence number that pixel intensity values at the same positions are respectively nᵢ and nⱼ in the i-th frame image gᵢ(x,y) and the j-th frame image gⱼ(x, y), a number of pixel pairs that pixel intensity values at same positions are not zero in the two images is summed up and denoted as M_{g}_{ᵢ}_{,g}_{ⱼ}, a mathematical expression of M_{g}_{ᵢ}_{,g}_{ⱼ} is as follows:

M_{g}_{ᵢ}_{,g}_{ⱼ}=Σₙ_{ᵢ}_{=1,n}_{ⱼ₌₁}K(nᵢ,nⱼ) (14)
where, M_{g}_{ᵢ}_{,g}_{ⱼ} represents a total number of pixel pairs that the pixel intensity values at the same positions are not zero in the two images; and the total number of pixel pairs combined with the occurrence number of a target pixel intensity pair is used to represent an occurrence probability of the target pixel intensity pair in the two images.

In an embodiment, a mathematical expression of the mutual information MI(gᵢ, gⱼ) in step (5) is represented by a formula (15) expressed as follows:

$$MI ( {g}_{i} , {g}_{j} ) = {\sum }_{{n}_{i} , {n}_{j}} \frac{K ( {n}_{i} , {n}_{j} )}{{M}_{{g}_{i} , {g}_{j}}} log \frac{\frac{K ( {n}_{i} , {n}_{j} )}{{M}_{{g}_{i} , {g}_{j}}}}{\frac{K ( {n}_{i} )}{{M}_{{g}_{i}}} \cdot \frac{K ( {n}_{j} )}{{M}_{{g}_{j}}}} \qquad ( 15 )$$

where a logarithmic term in the formula (15) represents a ratio of the joint probability to independent probabilities and is used to measure statistical correlation between the two images; a larger value of the logarithmic term indicates a stronger dependence between pixel intensity distributions of the two images; a sum part in the formula (15) represents integrating statistical relationships of all the pixel intensity pairs to obtain global mutual information; the mutual information MI(gᵢ, gⱼ) is used to quantify statistical dependence between the two images, a larger value of the mutual information indicates a stronger correlation between the pixel intensity distributions of the two images, that is the two images are more similar or the registration is better.

In an embodiment, the mutual information in step (6) is calculated by calculating normalized mutual information (NMI) to reduce impact of the sensitivity of the registration on the sizes of the overlapping regions. A mathematical expression of NMI is expressed as follows:

$$NMI ( {g}_{i} , {g}_{j} ) = \frac{MI ( {g}_{i} , {g}_{j} )}{E ( {g}_{i} ) + E ( {g}_{j} )} \qquad ( 16 )$$

where the normalized mutual information NMI(gᵢ, gⱼ) is used to standardize the mutual information MI(gᵢ, gⱼ) within a range [0,1], to facilitate comparing similarity of different image pairs.

In an embodiment, the optimization algorithm in step (7) includes differential evolution, gradient descent, and simulated annealing.

The optimization algorithm in step (7) is used to calculate the optimal registration parameters (Δx*, Δy*). A mathematical expression of the optimal registration parameters is as follows:

(Δx*,Δy*)=arg max_{Δx,Δy}MI(gᵢ(x,y),gᵢ(x+Δx,y+Δy)) (17)
where, gᵢ(x+Δx, y+Δy) represents an image obtained after translating an image gᵢ(x, y), Δx represents a horizontal offset, and Δy represents a vertical offset; arg max_{Δx,Δy} represents a group of translations that maximize the value of the mutual information among all available translation combinations of (Δx, Δy), to thereby obtain the optimal registration parameters (Δx*, Δy*), namely required horizontal offset and required vertical offset when image registration is best.

In an embodiment, a mathematical expression of the calculating and correcting global registration of the defocus series of electron microscopy images based on iteratively optimized value of mutual information in step (8) is as follows:

$${r}_{i} = {\sum }_{k = 1}^{m} [ Δ {x}_{ik} , Δ {y}_{i k} ] \qquad ( 18 )$$

where m represents a number of image pairs used for the registration during an optimizing process; [Δxᵢₖ, Δyᵢₖ] represents calculated optimal registration translations of the i-th frame image relative to a k-th frame image, rᵢ represents a global corrected displacement vector of the i-th frame image, namely total translations ultimately used to align the i-th frame image with a global reference image, to thereby improve robustness of the registration.

In a second aspect, a registration device for the defocus series of TEM images with high noise provided by the disclosure includes a memory and one or more processors. The memory is configured to store executable code. The one or more processors is configured to execute the executable code to implement the registration method for the defocus series of TEM images with high noise provided by the disclosure.

In a third aspect, a computer-readable storage medium is provided by the disclosure. A program is stored on the computer-readable storage medium. The program is executed by a processor to implement the registration method for the defocus series of TEM images with high noise.

A working principle of the disclosure is leveraging synergistic effects of the frequency-domain modulation and the information entropy optimization, specifically through the Fourier transform to extract amplitude information of structural signals and combined with multiple types of frequency-domain modulation functions to achieve noise spectral energy suppression and effective signal frequency band enhancement in the frequency domain; subsequently calculating the mutual information based on frequency-domain modulated images, and utilizing nonlinear correlation of frequency-domain signal statistical distributions to overcome a defect of noise sensitivity of intensity matching in the art, thereby driving robust registration.

Advantages of the disclosure are as follows.

The disclosure significantly reduces a registration error of the defocus series of TEM images with high noise, maintaining a registration success rate of over 99% under a high noise condition (SNR=−32.3 decibel, abbreviated as dB). Compared with methods in the art, such as GPC and CC, the registration error of the registration method provided by the disclosure is reduced from 26% to 0.8%. In addition, the registration method provided by the disclosure eliminates registration bias caused by defocus differences by quantifying statistical distribution similarity of the frequency-domain modulated images, rather than relying on defocus related intensity contrast. Registration error rates within drifts in a range of 2 nanometers (nm) to 100 nm are all less than 1%; therefore, the registration method provided by the disclosure has strong robustness and adaptability.

### BRIEF DESCRIPTION OF DRAWINGS

FIG. 1A through FIG. 1C illustrate distribution comparison diagrams of drifts (Δx*, Δy*) before and after registration; where FIG. 1A illustrates true distribution curves of the drifts (Δx*, Δy*), FIG. 1B illustrates distribution curves of the drifts (Δx*, Δy*) registered by CC, and FIG. 1C illustrates distribution curves of the drifts (Δx*, Δy*) registered by a registration method provided by the disclosure.

FIG. 2A through FIG. 2D illustrate comparison diagrams of an electron microscopy image before and after the registration; where FIG. 2A illustrates a single defocus image with high noise before the registration, FIG. 2B illustrates an electron microscopy image registered by the CC, FIG. 2C illustrates an electron microscopy image registered by the registration method provided by the disclosure, FIG. 2D illustrates a superposition diagram of a group of displacement-free and high-noise defocus images; a left one of two smaller pictures in each of FIG. 2A through FIG. 2D is an enlarged diagram of a unit structure, a right one of the two smaller pictures in each of FIG. 2A through FIG. 2D is an FFT diagram; and a white arc in the FFT diagram represents a size of resolution.

FIG. 3 illustrates a comparison diagram of RMS of different registration methods, where BP-CC refers to a Bandpass-CC algorithm.

FIG. 4A through FIG. 4B illustrate comparison diagrams of a reconstructed electron microscopy image registered by different registration methods; where FIG. 4A illustrates a reconstructed electron microscopy image registered by CC, FIG. 4B illustrates a reconstructed electron microscopy image registered by the registration method provided by the disclosure, a left one of two smaller pictures in each of FIG. 4A through FIG. 4B is an enlarged diagram of a unit structure, a right one of the two smaller pictures in each of FIG. 4A through FIG. 4B is an FFT diagram; and a white arc in the FFT diagram represents a size of resolution.

### DETAILED DESCRIPTION OF EMBODIMENTS

The disclosure will be described in detail as follows with reference to attached drawings and embodiments. The disclosure improves a registration method for defocus series of TEM images with high noise, achieving accurate registration for defocus series images of radiation-sensitive materials collected by electron microscopy at low dose. To verify feasibility and reliability of the disclosure, this embodiment uses simulated data of a hypothetical MOF material of materials of institute lavoisier (MIL)101 material to execute algorithms in the art, including GPC, CC, and bUnwarpJ, and the registration method improved by the disclosure, and compares results after registration. A main reason for using the simulated data is that the simulated data can exclude interference from external uncertain factors, such as astigmatism, thereby demonstrating effectiveness of the registration method provided by the disclosure for the defocus series of TEM images with high noise.

### Embodiment 1

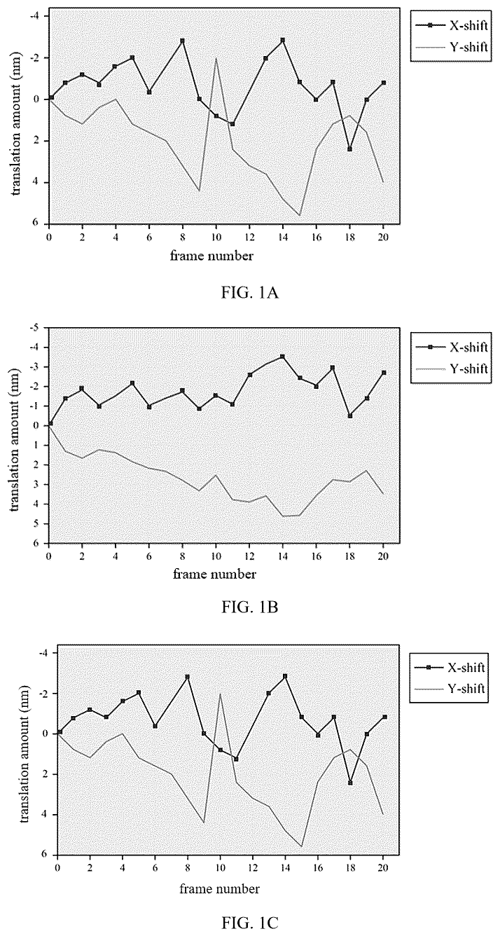

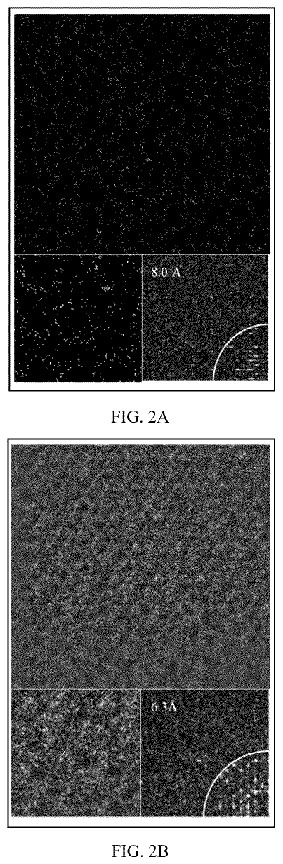

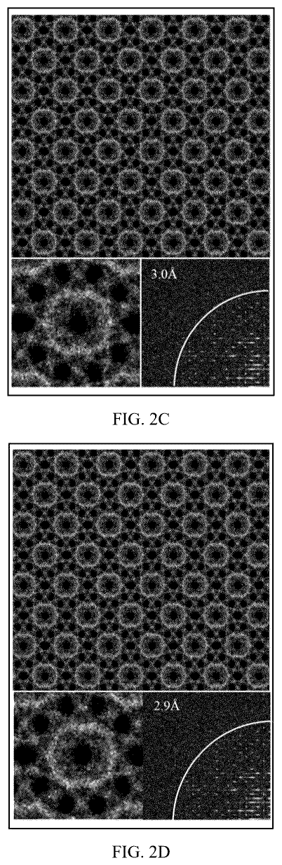

As illustrated in FIG. 1A through FIG. 3, a registration method for a defocus series of TEM images with high noise includes the following steps 1 through 9.
1. Firstly, projection of a MIL101 material under electron microscopy is simulated to generate a dataset with a size of 512×512×21 pixels. Data simulation conditions are as follows: an acceleration voltage of 300 kilovolts (kV), and defocus amounts of 2 nm, 5 nm, 10 nm, 20 nm, 50 nm, and 100 nm for image groups, respectively; and each of the image groups includes a complete series images ranging from defocus to in-focus to overfocus. Poisson noise with an intensity of 0.5 is added to each simulated image, to thereby obtain simulated defocus series of electron microscopy images and a SNR of the Poisson noise is −32.3, so as to simulate noise characteristics of low-dose imaging (as illustrated in FIG. 2A and FIG. 2D). Additionally, translation drifts are randomly introduced to simulate motion error in actual TEM imaging (as illustrated in FIG. 1A).

The low dose in the disclosure refers to an electron dose required to maintain inherent structures of extremely sensitive materials (such as MOF, mixed perovskite, and supramolecular crystals), which is usually much lower than 100 electrons per square angstrom (e−/Å²). In the embodiment, the SNR is −32.3, corresponding to a total electron dose of 3.8 e⁻/Å² for each simulated image. A negative SNR indicates that a signal is less than noise, i.e., the signal exhibits high-noise characteristics.
2. Each simulated image in the series images of the image groups is performed with Fourier transform. For an image stack (f₁(x, y), f₂(x, y), . . . , fₙ(x, y)) including n frame images, an original electron microscopy image inputted is set as fᵢ(x, y). Each frame image in the image stack is performed with the Fourier transform. An amplitude component (namely, a strength of a frequency-domain signal) of each frame image is extracted to thereby obtain amplitude components of all frame images of the image stack. The amplitude components of all frame images of the image stack are accumulated to form an amplitude pattern. The amplitude pattern is calculated according to a formula (1) expressed as follows:

$${F}_{A} ( u , v ) = {\sum }_{i = 1}^{n} \vert \int \int {f}_{i} ( x , y ) {e}^{- 2 π i ( u x + v y )} dx dy \vert . \qquad ( 1 )$$

Through accumulation of amplitude components of multi frame images, frequency-domain signals (such as Bragg reflection peak) of periodic structures (such as crystal lattice) are enhanced, and random noise is suppressed simultaneously.
3. The frequency-domain signals are enhanced. A modulation function H(u, v) is determined to enhance the amplitude component in the frequency-domain signal of each frame image performed with the Fourier transform and preserve original phase information e^{-iΦ(u,v)} simultaneously, to thereby obtain modulated frequency-domain signals. A formula (2) used for enhancing the frequency-domain signals is expressed as follows:

Gᵢ(u,v)=H(u,v)·e^{-iΦ(u,v)} (2).

In the embodiment, the modulation function is a soft threshold modulation function, which is used to accurately locate pixels in the amplitude pattern. When an intensity of the amplitude pattern is greater than a specified threshold, an enhanced frequency-domain information pattern is generated. The soft threshold modulation function is expressed as follows:

$$H ( u , v ) = \{ \begin{matrix}{F}_{A} ( u , v ) - {I}_{t} & if {F}_{A} ( u , v ) \geq {I}_{t} \\ 0 & if {F}_{A} ( u , v ) < {I}_{t}\end{matrix} \qquad ( 5 )$$

where the specified threshold Iₜ is defined as Iₜ=2×mean(F_{A})−min(F_{A}).
4. The modulated frequency-domain signals are performed with inverse Fourier transform, thereby obtaining denoised simulated series of electron microscopy images. A formula of the inverse Fourier transform is expressed as follows:

gᵢ(x,y)=∫∫Gᵢ(u,v)·e^{2πi(ux=+vy)}du dv (8).
5. Registration is optimized based on information entropy. The denoised simulated series of electron microscopy images are optimized through mutual information based on the information entropy, with a goal of finding optimal transformation parameters (translation, rotation, scaling, etc.) to maximize the mutual information of registered images. Firstly, it's assumed that an occurrence frequency of a pixel intensity value nᵢ in an image gᵢ(x,y) is K(nᵢ) and an occurrence frequency of a pixel intensity value nⱼ in an image gⱼ(x, y) is K(nⱼ). Numbers of non-zero pixel values in the image gᵢ(x, y) and the image gⱼ(x, y) are summed up and denoted as M_{g}_{ᵢ} and M_{g}_{ⱼ}, respectively. Mathematical expressions of M_{g}_{ᵢ} and M_{g}_{ⱼ} are as follows:

M_{g}_{ᵢ}=Σₙ_{ᵢ}₌₁K(nᵢ) (11)

M_{g}_{ⱼ}=Σₙ_{ⱼ}₌₁K(nⱼ) (12).

At the same time, an occurrence number of a pixel intensity value pair [nᵢ, nⱼ] of corresponding pixel positions in two images of the image gᵢ(x,y) and the image gⱼ(x,y) is assumed as K(nᵢ, nⱼ). A number of pixel intensity pairs that pixel intensity values at same positions are not zero in the two images is summed up and denoted as Mig. A mathematical expression of M_{g}_{ᵢ}_{,g}_{ⱼ} is as follows:

M_{g}_{ᵢ}_{,g}_{ⱼ}=Σₙ_{ᵢ}_{=1,n}_{ⱼ₌₁}K(nᵢ,nⱼ) (14).

Subsequently, marginal entropies of the image gᵢ(x,y) and the image gⱼ(x,y) are calculated and denoted as E(gᵢ) and E(gⱼ), respectively. Expressions of E(gᵢ) and E(gⱼ) are as follows:

$$E ( {g}_{i} ) = - {\sum }_{{n}_{i}} \frac{K ( {n}_{i} )}{{M}_{{g}_{i}}} \cdot log \frac{K ( {n}_{i} )}{{M}_{{g}_{i}}} \qquad ( 9 )$$

$$E ( {g}_{j} ) = - {\sum }_{{n}_{j}} \frac{K ( {n}_{j} )}{{M}_{{g}_{j}}} \cdot log \frac{K ( {n}_{j} )}{{M}_{{g}_{j}}} . \qquad ( 10 )$$

At the same time, a joint entropy of the two images is denoted as E(gᵢ, gⱼ). An expression of E(gᵢ, gⱼ) is as follows:

$$E ( {g}_{i} , {g}_{j} ) = - {\sum }_{{n}_{i ′} {n}_{j}} \frac{K ( {n}_{i} , {n}_{j} )}{{M}_{{g}_{i} , {g}_{j}}} \cdot log \frac{K ( {n}_{i} , {n}_{j} )}{{M}_{{g}_{i} , {g}_{j}}} . \qquad ( 13 )$$

Therefore, a calculation formula of the mutual information is as follows:

$$MI ( {g}_{i} , {g}_{j} ) = {\sum }_{{n}_{i} , {n}_{j}} \frac{K ( {n}_{i} , {n}_{j} )}{{M}_{{g}_{i} , {g}_{j}}} log \frac{\frac{K ( {n}_{i} , {n}_{j} )}{{M}_{{g}_{i} , {g}_{j}}}}{\frac{K ( {n}_{i} )}{{M}_{{g}_{i}}} \cdot \frac{K ( {n}_{j} )}{{M}_{{g}_{j}}}} . \qquad ( 15 )$$

6. The mutual information is normalized to reduce sensitivity of the mutual information on sizes of overlapping regions and improve robustness. A formula for normalizing the mutual information is as follows:

$$NMI ( {g}_{i} , {g}_{j} ) = \frac{MI ( {g}_{i} , {g}_{j} )}{E ( {g}_{i} ) + E ( {g}_{j} )} . \qquad ( 16 )$$

7. Multiscale optimization is performed. A value of mutual information and transformation parameters are optimized by using an optimization algorithm to find the optimal transformation parameters that maximize the value of mutual information. The optimization algorithm used in the embodiment is a differential evolution algorithm. A mathematical expression of the optimal transformation parameters is as follows:

(Δx*,Δy*)=arg max_{Δx,Δy}MI(g(x,y),gᵢ(x+Δx,y+Δy)) (17).

Displacement parameters (i.e., the transformation parameters) are visualized as two-dimensional coordinate curves, as illustrated in FIG. 1C. Curves of the displacement parameters registered by CC are illustrated in FIG. 1B.
8. Global registration of the simulated defocus series of electron microscopy images is calculated and corrected based on an iteratively optimized value of mutual information according to the following expression:

$${r}_{i} = {\sum }_{k = 1}^{m} [ Δ {x}_{ik} , Δ {y}_{i k} ] . \qquad ( 18 )$$

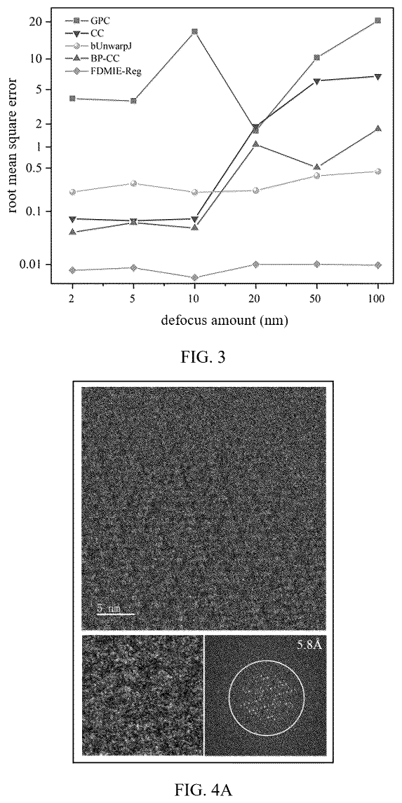

A registered image is illustrated in FIG. 2C. A registration result of CC is illustrated in FIG. 2B.
9. Registration results are assessed. Based on a quantified assessment standard of RMS, errors of registration transformation parameters Δx* and Δy* are analyzed. In an experiment of the embodiment, simulated defocus series of electron microscopy images in the image groups six in quantity are applied with different registration methods to obtain the registration results. Errors of the registration results are compared, as illustrated in FIG. 3. Experiment results show that the registration method provided by the disclosure significantly reduces a registration error of the defocus series of electron microscopy images under low dose. Compared with an average registration error of registration methods in the art of 26%, an average registration error of the registration method provided by the disclosure is reduced to 0.8%, which is far lower than that of registration methods in the art, such as GPC and CC. In addition, under a high noise condition (SNR=−32.3 dB), a registration success rate of the registration method provided by the disclosure is still over 99%, as illustrated in FIG. 2C, demonstrating strong robustness and adaptability.

### Embodiment 2

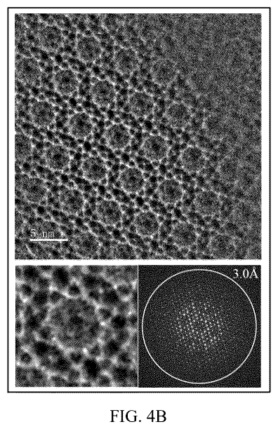

As illustrated in FIG. 4A and FIG. 4B, a registration method for defocus series of TEM images with high noise includes the following steps 1 through 9.
1. Firstly, a set of defocus series images is collected in a TEM with an acceleration voltage of 300 kV, an image size of 512×512 pixels, a collection focus range of −200 nm to +200 nm, and one image acquired at each 20 nm defocus interval, with a total electron dose of 5 e⁻/Å².

Low dose in the disclosure refers to an electron dose required to maintain inherent structures of extremely sensitive materials (such as MOF, mixed perovskite, and supramolecular crystals), which is usually much lower than 100 e⁻/Å². In the embodiment, the total electron dose is 5 e⁻/Å², corresponding to an SNR of −14.1. A negative SNR indicates that a signal is less than noise, i.e., the signal exhibits high-noise characteristics.

The set of defocus series images is performed with Fourier transform. For an image stack (f₁(x, y), f₂(x,y), . . . , fₙ(x, y)) including n frame images, an original electron microscopy image inputted is set as fᵢ(x, y). Each frame image in the image stack is performed with the Fourier transform. An amplitude component (namely, a strength of a frequency-domain signal) of each frame image is extracted to thereby obtain amplitude components of all frame images of the image stack. The amplitude components of all frame images of the image stack are accumulated to form an amplitude pattern. The amplitude pattern is calculated according to a formula (1) expressed as follows:

$${F}_{A} ( u , v ) = {\sum }_{i = 1}^{n} \vert \int \int {f}_{i} ( x , y ) {e}^{- 2 π i ( u x + v y )} dx dy \vert . \qquad ( 1 )$$

Through accumulation of amplitude components of multi frame images, frequency-domain signals (such as Bragg reflection peak) of periodic structures (such as crystal lattice) are enhanced, and random noise is suppressed.
3. The frequency-domain signals are enhanced. A modulation function H(u, v) is determined to enhance the amplitude component in the frequency-domain signal of each frame image performed with the Fourier transform and preserve original phase information e^{-iΦ(u,v)} simultaneously, to thereby obtain modulated frequency-domain signals. A formula (2) used for enhancing the frequency-domain signals is expressed as follows:

Gᵢ(u,v)=H(u,v)·e^{-iΦ(u,v)} (2).

In the embodiment, the modulation function is a soft threshold modulation function, which is used to accurately locate pixels in the amplitude pattern. When an intensity of the amplitude pattern is greater than a specified threshold, an enhanced frequency-domain information pattern is generated. The soft threshold modulation function is expressed as follows:

$$H ( u , v ) = \{ \begin{matrix}{F}_{A} ( u , v ) - {I}_{t} & if {F}_{A} ( u , v ) \geq {I}_{t} \\ 0 & if {F}_{A} ( u , v ) < {I}_{t}\end{matrix} \qquad ( 5 )$$

where the specified threshold Iₜ is defined as Iₜ=2×mean(F_{A})−min(F_{A}).
4. The modulated frequency-domain signals are performed with inverse Fourier transform, thereby obtaining denoised images. A formula of the inverse Fourier transform is expressed as follows:

gᵢ(x,y)=∫∫Gᵢ(u,v)·e^{2πi(ux=+vy)}du dv (8).
5. Registration is optimized based on information entropy. The denoised images are optimized through mutual information based on the information entropy, with a goal of finding optimal transformation parameters (translation, rotation, scaling, etc.) to maximize the mutual information of registered images. Firstly, it's assumed that an occurrence frequency of a pixel intensity value nᵢ in an image gᵢ(x,y) is K(nᵢ), and an occurrence frequency of a pixel intensity value nⱼ in an image gⱼ(x, y) is K(nⱼ). Numbers of non-zero pixel values in the image gᵢ(x, y) and the image gⱼ(x, y) are summed up and denoted as M_{g}_{ᵢ} and M_{g}_{ⱼ}, respectively. Mathematical expressions of M_{g}_{ᵢ} and M_{g}_{ⱼ} are as follows:

M_{g}_{ᵢ}=Σₙ_{ᵢ}₌₁K(nᵢ) (11)

M_{g}_{ⱼ}=Σₙ_{ⱼ}₌₁K(nⱼ) (12).

At the same time, an occurrence number of a pixel intensity value pair [nᵢ, nⱼ] of corresponding pixel positions in two images of the image gᵢ(x,y) and the image gⱼ(x,y) is assumed as K(nᵢ, nⱼ). A number of pixel intensity pairs that pixel intensity values at same positions are not zero in the two images is summed up and denoted as M_{g}_{ᵢ}_{,g}_{ⱼ}. A mathematical expression of M_{g}_{ᵢ}_{,g}_{ⱼ} is as follows:

M_{g}_{ᵢ}_{,g}_{ⱼ}=Σₙ_{ᵢ}_{=1,n}_{ⱼ₌₁}K(nᵢ,nⱼ) (14).

Subsequently, marginal entropies of the image gᵢ(x,y) and the image gⱼ(x,y) are calculated and denoted as E(gᵢ) and E(gⱼ), respectively. Expressions of E(gᵢ) and E(gⱼ) are as follows:

$$E ( {g}_{i} ) = - {\sum }_{{n}_{i}} \frac{K ( {n}_{i} )}{{M}_{{g}_{i}}} \cdot log \frac{K ( {n}_{i} )}{{M}_{{g}_{i}}} \qquad ( 9 )$$

$$E ( {g}_{j} ) = - {\sum }_{{n}_{j}} \frac{K ( {n}_{j} )}{{M}_{{g}_{j}}} \cdot log \frac{K ( {n}_{j} )}{{M}_{{g}_{j}}} . \qquad ( 10 )$$

At the same time, a joint entropy of the two images is denoted as E(gᵢ, gⱼ). An expression of E(gᵢ, gⱼ) is as follows:

$$E ( {g}_{i} , {g}_{j} ) = - {\sum }_{{n}_{i} , {n}_{j}} \frac{K ( {n}_{i} , {n}_{j} )}{{M}_{{g}_{i} , {g}_{j}}} \cdot log \frac{K ( {n}_{i} , {n}_{j} )}{{M}_{{g}_{i} , {g}_{j}}} . \qquad ( 13 )$$

Therefore, a calculation formula of the mutual information is as follows:

$$MI ( {g}_{i} , {g}_{j} ) = {\sum }_{{n}_{i} , {n}_{j}} \frac{K ( {n}_{i} , {n}_{j} )}{{M}_{{g}_{i} , {g}_{j}}} log \frac{\frac{K ( {n}_{i} , {n}_{j} )}{{M}_{{g}_{i} , {g}_{j}}}}{\frac{K ( {n}_{i} )}{{M}_{{g}_{i}}} \cdot \frac{K ( {n}_{j} )}{{M}_{{g}_{j}}}} . \qquad ( 15 )$$

6. The mutual information is normalized to reduce sensitivity of the mutual information on sizes of overlapping regions and improve robustness. A formula for normalizing the mutual information is as follows:

$$NMI ( {g}_{i} , {g}_{j} ) = \frac{MI ( {g}_{i} , {g}_{j} )}{E ( {g}_{i} ) + E ( {g}_{j} )} . \qquad ( 16 )$$

7. Multiscale optimization is performed. A value of mutual information and transformation parameters are optimized by using an optimization algorithm to find the optimal transformation parameters that maximize the value of mutual information. The optimization algorithm used in the embodiment is a differential evolution algorithm. A mathematical expression of the optimal transformation parameters is as follows:

(Δx*,Δy*)=arg max_{Δx,Δy}MI(gᵢ(x,y),gᵢ(x+Δx,y+Δy)) (17).
8. Global registration of the defocus series images is calculated and corrected based on an iteratively optimized value of mutual information iteratively optimized according to the following expression:

$${r}_{i} = {\sum }_{k = 1}^{m} [ Δ {x}_{ik} , Δ {y}_{i k} ] . \qquad ( 18 )$$

9. A registration result is assessed. A registered defocus series of images obtained in step 8 are treated and reconstructed to obtain a reconstructed electron microscopy image. A resolution of the reconstructed electron microscopy image registered by the registration method provided in the disclosure is improved to below 3.0 angstrom (Å), as illustrated in FIG. 4B. However, a resolution of a reconstructed electron microscopy image obtained by registering and reconstructing the defocus series images by a registration method CC in the art is limited to 5.8 Å, as illustrated in FIG. 4A. It can be seen that the registration method provided in the disclosure is compatible with imaging requirements of radiation-sensitive materials and can preserve high-frequency structural features of a sample through frequency-domain modulation when the total electron dose is lower than 5 e⁻/Å².

### Embodiment 3

The embodiment relates to a registration device for a defocus series of TEM images with high noise, including a memory and one or more processors. The memory is configured to store executable code. The one or more processors is configured to execute the executable code to implement the registration method for the defocus series of TEM images with high noise provided by embodiment 1.

### Embodiment 4

The embodiment relates to a computer-readable storage medium. A program is stored on the computer-readable storage medium. The program is executed by a processor to implement the registration method for the defocus series of TEM images with high noise provided in embodiment 1.

Content described in the embodiments of the specification is only an enumeration of implementation forms of a concept of the disclosure. A scope of protection of the disclosure should not be regarded as limited to specific forms described in the embodiments. The scope of protection of the disclosure also includes equivalent technical means that can be conceived by those skilled in the art based on the concept of the disclosure.

What is claimed is:

1. A registration method for a defocus series of transmission electron microscopy images with high noise, comprising the following steps:
(1) obtaining a defocus series of electron microscopy images with high noise;
(2) performing Fourier transform on the defocus series of electron microscopy images:
applying the Fourier transform frame by frame to the obtained defocus series of electron microscopy images, to extract an amplitude component of each frame of the defocus series of electron microscopy images to thereby obtain amplitude components of frames of the defocus series of electron microscopy images, and accumulating the amplitude components of the frames of the defocus series of electron microscopy images to form a frequency-domain amplitude pattern, thereby enhancing periodic structural signals and suppressing random noise;
(3) enhancing frequency-domain signals: determining a modulation function to modulate the amplitude components in a frequency domain and preserve original phase information simultaneously, to thereby obtain modulated frequency-domain signals;
(4) performing inverse Fourier transform: performing the inverse Fourier transform on the modulated frequency-domain signals to obtain a denoised series of electron microscopy images;
(5) optimizing registration based on information entropy: calculating mutual information of the denoised series of electron microscopy images, wherein the mutual information is calculated through the following steps:
counting occurrence frequencies of each pixel intensity value in two images at different frames of the denoised series of electron microscopy images, to thereby obtain frequency ratios;
calculating marginal entropies of the two images, respectively, based on the frequency ratios;
counting joint frequency distribution of a pixel intensity value pair at corresponding positions between the two images, to thereby obtain a joint frequency ratio;
calculating a joint information entropy based on the joint frequency ratio; and
subtracting the joint information entropy from a sum of the marginal entropies of the two images, to thereby obtain the mutual information;
(6) normalizing the mutual information to reduce sensitivity on sizes of overlapping regions;
(7) performing multi-scale optimization: optimizing a value of the mutual information and registration parameters by using an optimization algorithm, to thereby obtain optimal registration parameters that maximize the value of the mutual information;
(8) calculating correction values based on iteratively optimized value of the mutual information and iteratively optimized registration parameters, and registering, based on the correction values, the defocus series of electron microscopy images obtained in step (1), to thereby obtain a registered defocus series of electron microscopy images; and
(9) assessing registration results: establishing control groups, applying different registration methods to the control groups to obtain registered defocus series of electron microscopy images of the control groups, and quantitatively evaluating registration parameters of the registered defocus series of electron microscopy images of the control groups and the registered defocus series of electron microscopy images obtained in step (8) through a root mean square (RMS) error to thereby validate a registration accuracy of each of the control groups and a registration accuracy of the registered defocus series of electron microscopy images obtained in step (8); and registering a defocus series of electron microscopy images obtained by an actually low-dose technique through step (2) to step (8), followed by reconstructing to obtain a structural image, and comparing a resolution of the structural image with that of a structural image obtained by registering and reconstructing a target control group by a target registration method, to thereby validate registration levels.

2. The registration method as claimed in claim 1, wherein the defocus series of electron microscopy images in step (2) comprise n frame images, thereby forming an image stack; an i-th frame image of the n frame images is expressed as fᵢ(x, y); (x,y) corresponds to a projection position of a sample in a two-dimensional space during transmission electron microscopy acquisition, x is a horizontal coordinate, and y is a vertical coordinate; a value of fᵢ(x,y) represents a strength of an electronic signal detected by a detector at the projection position; the frequency-domain amplitude pattern is expressed as F_{A}(u,v), u and v represent contributions of different frequency components in a spatial frequency, u corresponds to a horizontal frequency, and v corresponds to a vertical frequency; a value of F_{A}(u,v) represents a result of the Fourier transform, and a mathematical meaning of the Fourier transform is to map a spatial domain to the frequency domain; the Fourier transform is calculated through a fast Fourier transform (FFT), and F_{A} (u, v) is calculated according to a formula (1) expressed as follows:
$${F}_{A} ( u , v ) = {\sum }_{i = 1}^{n} \vert \int \int {f}_{i} ( x , y ) {e}^{- 2 π i ( u x + v y )} dx dy \vert \qquad ( 1 )$$
where, an integral part in the formula (1) refers to performing continuous Fourier transform on a single frame image fᵢ(x, y), specifically calculating an inner product of the i-th frame image fᵢ(x, y) with a complex exponential wave e^{-2πi(ux+vy)} corresponding to the i-th frame image fᵢ(x, y) to quantify a contribution of each frequency component at a frequency point (u, v) in the i-th frame image fᵢ(x, y), namely calculating a complex value of the single frame image fᵢ(x, y) at a frequency point (u, v); an absolute value part in the formula (1) refers to taking a magnitude spectrum of the Fourier transform, namely a modulus of the Fourier transform; and a summation part in the formula (1) represents superposition of frequency spectra of the n frame images, to thereby ultimately obtain F_{A} (u, v).

3. The registration method as claimed in claim 1, wherein the modulation function in step (3) comprises a Gaussian modulation function, a Wiener modulation function, a soft threshold modulation function, a Gaussian high pass modulation function, and a median modulation function; and
wherein a formula (2) used for enhancing the frequency-domain signals in step (3) is expressed as follows:
Gᵢ(u,v)=H(u,v)·e^{-iΦ(u,v)} (2)
where Φ(u, v) represents a phase angle of a frequency signal, and a physical meaning of phase is to determine a spatial position of a periodic structure in a signal; Φ(u, v) in the formula (2) originates from an original signal of an image, meaning that phase information of the image remains unchanged; e^{-iΦ(u,v)} represents the original phase information of a frequency point (u, v) in an i-th frame image and is used to encode the original phase information into a complex form to facilitate synthesis of a frequency-domain signal; H(u, v) represents the modulation function and is used to modulate the amplitude components in the frequency domain; and Gᵢ(u, v) represents an enhanced signal of the frequency point (u, v) in the i-th frame image, comprises modulated amplitude and phase information, and is used for subsequent inverse Fourier transform to reconstruct an enhanced spatial-domain signal.

4. The registration method as claimed in claim 1, wherein a mathematical expression of the inverse Fourier transform in step (4) is represented by a formula (8) expressed as follows:
gᵢ(x,y)=∫∫Gᵢ(u,v)·e^{2πi(ux=+vy)}du dv (8)
where gᵢ(x,y) represents a spatial-domain signal recovered from a frequency-domain signal Gᵢ(u, v) through the inverse Fourier transform and comprises modulated or corrected information, namely an i-th frame image in the denoised series of electron microscopy images; e^{2πi(ux=+vy)} represents conversion of each frequency component (u, v) of the frequency-domain signal Gᵢ(u, v) into a plane wave in a spatial domain; and an integral part in the formula (8) represents recombination of frequency components separated in the frequency domain to restore global features and local features of the i-th frame image in the spatial domain.

5. The registration method as claimed in claim 1, wherein a mathematical expression of the mutual information MI(gᵢ, gⱼ) in step (5) is represented by a formula (15) expressed as follows:
$$MI ( {g}_{i} , {g}_{j} ) = {\sum }_{{n}_{i} , {n}_{j}} \frac{K ( {n}_{i} , {n}_{j} )}{{M}_{{g}_{i} , {g}_{j}}} log \frac{\frac{K ( {n}_{i} , {n}_{j} )}{{M}_{{g}_{i} , {g}_{j}}}}{\frac{K ( {n}_{i} )}{{M}_{{g}_{i}}} \cdot \frac{K ( {n}_{j} )}{{M}_{{g}_{j}}}} \qquad ( 15 )$$
where M_{g}_{ᵢ} represents a total number of non-zero pixel values in an image gᵢ(x, y), M_{g}_{ⱼ} represents a total number of non-zero pixel values in an image gⱼ(x, y); gᵢ(x, y) and gⱼ(x, y) represent an i-th frame image and a j-th frame image in an image stack with n frame images performed with the inverse Fourier transform, respectively; calculating the marginal entropies E(gᵢ) and E(gⱼ) is necessarily based on inputting an occurrence frequency K(nᵢ) of a pixel intensity value nᵢ in the i-th frame image gᵢ(x,y) and an occurrence frequency K(nⱼ) of a pixel intensity value nⱼ in the j-th frame image gⱼ (x, y); nᵢ represents an intensity value of a target pixel in the i-th frame image g₁(x,y), and nⱼ represents an intensity value of another target pixel in the j-th frame image gⱼ(x, y) at a position corresponding to a position of the target pixel in the i-th frame image gᵢ(x, y); numbers of the non-zero pixel values in the i-th frame image gᵢ(x, y) and the j-th frame image gⱼ(x, y) are summed up and denoted as M_{g}_{ᵢ} and M_{g}_{ⱼ}, respectively; a total number combined with an occurrence frequency is used to represent an occurrence probability of a pixel intensity value in a single image, namely an independent probability of each image; M_{g}_{ᵢ}_{,g}_{ⱼ} represents a total number of pixel pairs that pixel intensity values at same positions are not zero in the i-th frame image gᵢ(x, y) and the j-th frame image gⱼ(x, y), and K(nᵢ, nⱼ) represents an occurrence number that pixel intensity values at the same positions are respectively nᵢ and nⱼ in the i-th frame image gᵢ(x, y) and the j-th frame image gⱼ (x, y); the total number of pixel pairs combined with the occurrence number of a target pixel intensity pair is used to represent an occurrence probability of the target pixel intensity pair in two images, namely a joint probability of the two images; a logarithmic term in the formula (15) represents a ratio of the joint probability to independent probabilities and is used to measure statistical correlation between the two images; a larger value of the logarithmic term indicates a stronger dependence between pixel intensity distributions of the two images; a sum part in the formula (15) represents integrating statistical relationships of all the pixel pairs to obtain global mutual information; the mutual information MI(gᵢ,gⱼ) is used to quantify statistical dependence between the two images, a larger value of the mutual information indicates a stronger correlation between the pixel intensity distributions of the two images, that is the two images are more similar or the registration is better.

6. The registration method as claimed in claim 1, wherein the mutual information in step (6) is calculated through calculating normalized mutual information (NMI) to reduce impact of the sensitivity of registration on the sizes of the overlapping regions, and a mathematical expression of NMI is expressed as follows:
$$NMI ( {g}_{i} , {g}_{j} ) = \frac{MI ( {g}_{i} , {g}_{j} )}{E ( {g}_{i} ) + E ( {g}_{j} )} \qquad ( 16 )$$
where the normalized mutual information NMI(gᵢ, gⱼ) is used to standardize the mutual information MI(gᵢ, gⱼ) within a range of [0,1], to thereby facilitate comparing similarity of different image pairs.

7. The registration method as claimed in claim 1, wherein the optimization algorithm in step (7) comprises differential evolution, gradient descent, and simulated annealing; and
wherein the optimization algorithm in step (7) is used to calculate the optimal registration parameters (Δx*, Δy*), and a mathematical expression of the optimal registration parameters is as follows:
(Δx*,Δy*)=arg max_{Δx,Δy}MI(gᵢ(x,y),gᵢ(x+Δx,y+Δy)) (17)
where, gᵢ(x+Δx, y+Δy) represents an image obtained after translating an image gᵢ(x, y), Δx represents a horizontal offset, and Δy represents a vertical offset; arg max_{Δx,Δy} represents a group of translations that maximize the value of the mutual information among all available translation combinations of (Δx, Δy), to thereby obtain the optimal registration parameters (Δx*,Δy*), namely required horizontal offset and required vertical offset when image registration is best.

8. The registration method as claimed in claim 1, wherein a mathematical expression of the calculating correction values based on the value of iteratively optimized mutual information and iteratively optimized registration parameters is as follows:
$${r}_{i} = {\sum }_{k = 1}^{m} [ Δ {x}_{ik} , Δ {y}_{i k} ] . \qquad ( 18 )$$
where m represents a number of image pairs used for the registration during an optimizing process, [Δxᵢₖ, Δyᵢₖ] represents calculated optimal registration translations of an i-th frame image relative to a k-th frame image, rᵢ represents a global corrected displacement vector of the i-th frame image, namely total translations ultimately used to align the i-th frame image with a global reference image, to thereby improve robustness of the registration.

9. A registration device for a defocus series of transmission electron microscopy images with high noise, comprising a memory and one or more processors, wherein the memory is configured to store executable code, and the one or more processors is configured to execute the executable code to implement the registration method for the defocus series of transmission electron microscopy images with high noise as claimed in claim 1.

10. A computer-readable storage medium, wherein a program is stored on the computer-readable storage medium, and the program is executed by a processor to implement the registration method for the defocus series of transmission electron microscopy images with high noise as claimed in claim 1.
